(19) United States
(12) Patent Application Publication
(10) Pub. No.: US 2024/0288833 A1
(43) Pub. Date: Aug. 29, 2024

(54) WEARABLE DEVICE

(71) Applicant: HUAWEI TECHNOLOGIES CO., LTD., SHENZHEN, GUANGDONG (CN)

(72) Inventors: Rongguang YANG, Shenzhen (CN); Menglong ZHAO, Xi’an (CN); Qian HE, Xi’an (CN); Bing LIU, Xi’an (CN); Jianming GAO, Xi’an (CN); Qinjun PAN, Dongguan (CN)

(21) Appl. No.: 18/564,240

(22) PCT Filed: May 27, 2022
(86) PCT No.: PCT/CN2022/095740

§ 371 Date: Nov. 27, 2023

(30) Foreign Application Priority Data
May 28, 2021 (CN) 202121181485.0
Nov. 16, 2021 (CN) 202111358522.5

(51) Int. Cl. G04G 17/04; H01Q 1/27

(52) U.S. Cl. CPC G04G 17/04; H01Q 1/273

(57) ABSTRACT

Embodiments of this application disclose a wearable device. The wearable device includes a wearable device body and a housing that covers the wearable device body. The housing is made of an insulating material, the housing includes at least two spring bars, two spring bars are arranged in parallel and spaced from each other and both extend in a same direction, a connection line between ends of the two spring bars is located outside the wearable device, and a conductive component is disposed on the spring bar. The wearable device body includes a mainboard, the mainboard is configured to feed power to the conductive component, and the conductive component is used as an antenna.

This application is a national stage of International Application No. PCT/CN2022/095740, filed on May 27, 2022, which claims priorities to Chinese Patent Application No. 202121181485.0, filed on May 28, 2021 and Chinese Patent Application No. 202111358522.5, filed on Nov. 16, 2021. All of the aforementioned applications are hereby incorporated by reference in their entireties.

### TECHNICAL FIELD

Embodiments of this application relate to the field of wearable device technologies, and in particular, to a wearable device.

### BACKGROUND

With the maturity of mobile communication technologies, wearable devices become increasingly intelligent, and may integrate many functions. For example, functions such as motion data collection, global positioning, and communication are integrated into a smartwatch, a smart band, and the like. In a wearable device such as a smartwatch or a smart band, an antenna needs to be integrated to implement related information receiving functions.

In the conventional technology, a metal watch case of a smartwatch may be used as an antenna of the smartwatch. A seamless design is usually used for the metal watch case.

In addition, the metal watch case is provided with four spring bars, and a metal spring bar shaft is disposed between each pair of spring bars that fasten a watchband end. A conventional spring bar shaft includes a metal tube, and pins, levers, and spring mechanisms on both sides, and is of an integrated metal component structure. If two spring bars are externally communicatively connected by a spring bar shaft, antenna performance is significantly reduced. Usually, the metal housing is further connected to a structure such as a watchband. In addition, to be beautiful and durable, the watchband is usually made of metal materials.

However, the metal housing of an intelligent wearable device in the conventional technology is used as an antenna, and has a current flow route. After the watchband made of the metal materials is connected to the metal housing through the spring bar shaft, the original metal housing is electrically connected to the watchband, affecting an original antenna circuit. Consequently, an antenna function of the smartwatch is affected, and the antenna performance is reduced.

### SUMMARY

Embodiments of this application provide a wearable device, to resolve a problem of poor antenna performance of an existing wearable device.

To achieve the foregoing objective, embodiments of this application use the following technical solutions: Embodiments of this application provide a wearable device, including a wearable device body and a housing that covers the wearable device body, where the housing is made of an insulating material, the housing includes at least two spring bars, two spring bars are arranged in parallel and spaced from each other and both extend in a same direction, a connection line between ends of the two spring bars is located outside the wearable device body, and a conductive component is disposed on the spring bar. The wearable device body includes a mainboard, the mainboard is configured to feed power to the conductive component, and the conductive component is used as an antenna. Therefore, the spring bar is made of the insulating material, and the conductive component is embedded in the spring bar to avoid contact between the conductive component and the spring bar shaft, so that impact on an antenna signal caused by a connection between the spring bar shaft and the conductive component can be avoided, the antenna performance of the whole machine is ensured, a seamless design of a whole watch case is also taken into consideration, and the surface integrity is implemented.

In an embodiment, the housing includes a circle case disposed surrounding the wearable device body, the spring bar is disposed on the circle case, and a part of the conductive component is disposed in the circle case. Therefore, an area of the antenna is increased.

In an embodiment, two spring bars on a same side are communicatively connected to each other through a beam, and a part of the conductive component is embedded in the beam. In this way, the conductive component is extended to the beam, and the area of the antenna is further increased.

In an embodiment, the conductive component includes a first part disposed on the circle case, a second part disposed on the spring bar, and a third part disposed on the beam. The first part, the second part, and the third part are connected, and there is a slit on the third part. The antenna formed in this way can implement dual frequencies, to further improve the antenna performance.

In an embodiment, a location of the slit is close to the spring bar. Certainly, the slit may also be disposed at another location.

In an embodiment, the first part has a grounding point electrically connected to the mainboard. By setting the grounding point, the length of the mainboard can be equivalently extended to improve the antenna performance.

In an embodiment, a first protruding part is formed on a side surface that is of the first part and that is opposite to the third part, a second protruding part is formed on a side surface that is of the third part and that is opposite to the first part, and the first protruding part is electrically isolated from the second protruding part. The first protruding part and the second protruding part herein may be used as reinforcing ribs of the antenna to improve strength of the antenna.

In an embodiment, the conductive component is embedded in the spring bar. In this way, the conductive component is integrated with a plastic watch case through an insert molding manner or another similar molding manner, and is embedded and hidden inside the plastic watch case, to avoid contact between the antenna and the outside, reduce interference from an external environment to the antenna, and improve performance of the antenna.

In an embodiment, the conductive component is formed on the surface of the spring bar. Therefore, an operation is simpler, which helps improve production efficiency.

In an embodiment, the conductive component is electrically connected to the mainboard through an electrical connecting member. In this way, the mainboard may feed power to the conductive component through the electrical connecting member, so that the conductive component may be used as an antenna to radiate an electromagnetic wave.

In an embodiment, the mainboard feeds power to the conductive component in a coupling manner. In this way, the mainboard may feed power to the conductive component in the coupling manner, so that the conductive component may be used as an antenna to radiate an electromagnetic wave.

In an embodiment, the electrical connecting member is one of a screw, a metal dome, conductive plastic, and a flexible printed circuit FPC. Therefore, there are more selections of the electrical connecting member, and the structure is flexible, applicable to a plurality of working scenarios.

In an embodiment, the housing includes a front housing and a rear housing, and the conductive component is disposed in the front housing. A first connecting member is further disposed in the front housing, and a second connecting member is disposed in the rear housing. The first connecting member is detachably connected to the second connecting member. Therefore, the front housing and the rear housing may be detachably connected to each other.

In an embodiment, the first connecting member is embedded in the front housing. Therefore, the insert molding process is mature and facilitates production.

In an embodiment, the first connecting member and the conductive component are integrally formed. Therefore, an integration degree of whole wearable device is promoted.

In an embodiment, a sealing gasket is disposed between the rear housing and the second connecting member. In this way, the front housing and the rear housing can be better sealed, an interface waterproof capability of the insert molding is improved, and sealing performance of the entire wearable device is improved.

In an embodiment, the first connecting member is a screw, and the second connecting member is a nut. Therefore, the first connecting member and the second connecting member may be detachably connected, to facilitate disassembly and assembly of the entire wearable device.

In an embodiment, the conductive component includes a plurality of modules, and different modules correspond to different operating frequency bands. In this way, each module may be independently used as an antenna module of a signal frequency band, thereby bringing better antenna performance to the watch than a conventional antenna structure.

In an embodiment, the wearable device further includes: a spring bar shaft, where one spring bar hole is provided on each of the two spring bars, two spring bar holes are coaxially disposed, two spring bar shafts extend into the two spring bar holes and are rotatably connected to the spring bar holes, and the spring bar shaft and the conductive component are spaced from each other. In this way, contact between the spring bar shaft and the conductive component is avoided, and performance of the antenna is improved.

In an embodiment, the wearable device further includes a band body, and the band body is rotatably connected to the spring bar shaft. Therefore, it is convenient for the user to wear the wearable device.

### BRIEF DESCRIPTION OF DRAWINGS

FIG. 1 is a schematic diagram of a structure of a smartwatch;

FIG. 2 is a schematic diagram of a structure of another smartwatch;

FIG. 3 is a schematic diagram of a structure of installing a spring bar shaft on a smartwatch body of a smartwatch;

FIG. 4 is a schematic diagram of a structure of a wearable device according to an embodiment of this application;

FIG. 5 is a schematic diagram of a structure of disposing an antenna module on a wearable device according to an embodiment of this application;

FIG. 6 is a schematic diagram of a disassembled structure of a housing of a wearable device according to an embodiment of this application;

FIG. 7 is a schematic diagram of a connection between an antenna module and a mainboard of a wearable device according to an embodiment of this application;

FIG. 8 is a sectional view along an A-A direction in FIG. 7;

FIG. 9 is a schematic diagram of another connection between an antenna module and a mainboard of a wearable device according to an embodiment of this application;

FIG. 10 is a sectional view along an A-A direction in FIG. 9;

FIG. 11 is a schematic diagram of a disassembled structure of a housing of a wearable device according to an embodiment of this application;

FIG. 12 is a schematic diagram of a structure of the housing in FIG. 11;

FIG. 13 is a schematic diagram of another disassembled structure of a housing of a wearable device according to an embodiment of this application;

FIG. 14 is a schematic diagram of a structure of the housing in FIG. 13;

FIG. 15 is a schematic diagram of a structure of another antenna module according to an embodiment of this application;

FIG. 16 is a schematic diagram of another structure of disposing an antenna module on a wearable device according to an embodiment of this application;

FIG. 17a is a schematic diagram of a structure of another antenna module according to an embodiment of this application;

FIG. 17b is a schematic diagram of a structure of another antenna module according to an embodiment of this application;

FIG. 17c is a schematic diagram of a structure of another antenna module according to an embodiment of this application;

FIG. 17d is a schematic diagram of a structure of another antenna module according to an embodiment of this application;

FIG. 18 is a schematic diagram of another structure of disposing an antenna module on a wearable device according to an embodiment of this application;

FIG. 19 is a schematic diagram of another structure of disposing an antenna module on a wearable device according to an embodiment of this application;

FIG. 20 is a schematic diagram of a structure of an antenna module according to an embodiment of this application;

FIG. 21 is a schematic diagram of a structure of another antenna module according to an embodiment of this application;

FIG. 22 is a schematic diagram of a structure of another antenna module according to an embodiment of this application;

FIG. 23 is a schematic diagram of a structure of another antenna module according to an embodiment of this application;

FIG. 24 is a schematic diagram of a structure of another antenna module according to an embodiment of this application;

FIG. 25 is a schematic diagram of a structure of another antenna module according to an embodiment of this application;

FIG. 26 is a schematic diagram of a structure of another antenna module according to an embodiment of this application; and

FIG. 27 is a schematic diagram of a structure of another antenna module according to an embodiment of this application.

### DESCRIPTION OF EMBODIMENTS

To make the objective, technical solutions, and advantages of this application clearer, the following further describes this application in detail with reference to the accompanying drawings.

Terms such as “first” and “second” mentioned below are merely used for description objectives, but shall not be understood as an indication or implication of relative importance, or implicit indication of a quantity of indicated technical features. Therefore, it is defined as follows: A feature with “first”, “second”, or the like may explicitly or implicitly include one or more such features. In description of this application, unless otherwise stated, “a plurality of” means two or more.

In addition, in this application, orientation terms such as “up” and “down” are defined relative to schematic placement orientations of components shown in the accompanying drawings. It should be understood that these directional terms are relative concepts and are used for relative description and clarification, and may vary correspondingly based on changes of the placement orientations of the components in the accompanying drawings.

The following describes terms that may appear in embodiments of this application.

Electrical connection: may be understood as a form in which components are in physical contact and are electrically connected, or may be understood as a form in which different components in a line structure are connected through a physical line that can transmit an electrical signal, such as a PCB copper foil or a conducting wire. “Connection” is a connection of mechanical structures and physical structures.

Coupling: is a phenomenon that two or more circuit elements or an input and an output of an electrical network closely cooperate with each other and affect each other, and energy is transmitted from one side to another side through interaction.

Conductive connection: Two or more components are electrically connected or communicatively connected through the foregoing “electrical connection” or “coupling connection” manners to perform signal/energy transmission, which may be referred to as conductive connection.

Spring bar shaft: is a connecting rod that connects a watchband to a watch dial.

Spring bar: is a protruding part of a watch case, and is configured to connect to the watchband.

Global navigation satellite system (GNSS): The global navigation satellite system GNSS may include a global positioning system (GPS), a global navigation satellite system (GLONASS), a BeiDou navigation satellite system (BDS), a quasi-zenith satellite system (QZSS), and/or a satellite-based augmentation system (SBAS).

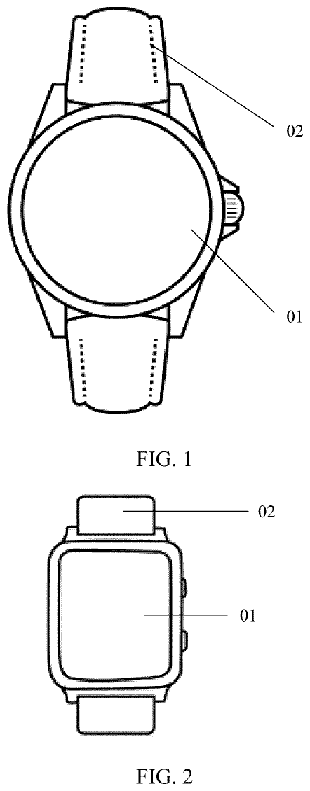

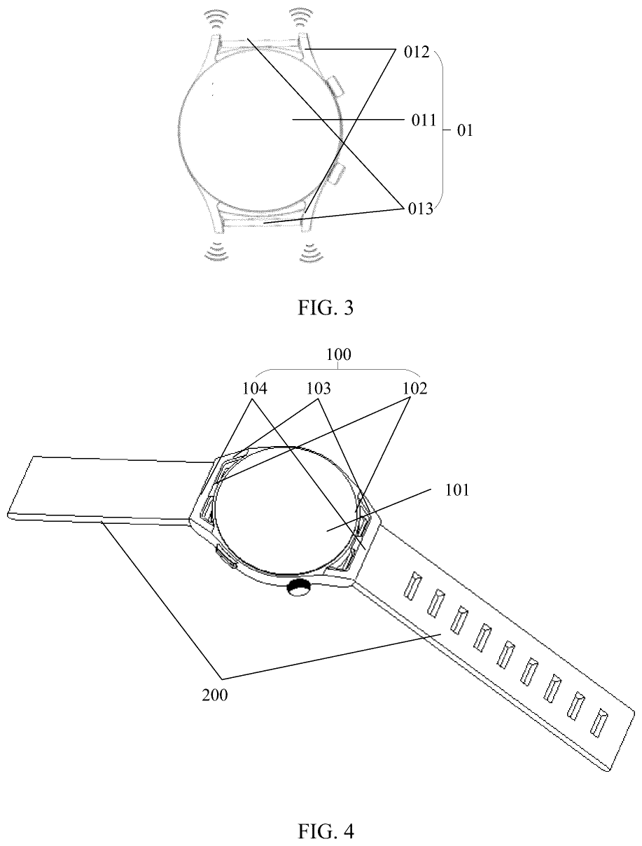

FIG. 1 is a schematic diagram of a structure of a smartwatch. FIG. 2 is a schematic diagram of a structure of another smartwatch. Refer to FIG. 1 and FIG. 2. A smartwatch in the conventional technology includes a watch body 01 and a watchband 02 connected to the watch body 01. FIG. 3 is a schematic diagram of a structure of installing a spring bar shaft on a smartwatch body of a smartwatch. Refer to FIG. 3. A watch body 01 includes a metal watch case 011 and four spring bars 012 disposed outside the watch body 01. Two spring bars 012 form a group and are disposed opposite to each other, and a spring bar shaft 013 is installed. The spring bar shaft 013 is configured to connect the watch body 01 to the watchband 02. To implement transmission of a plurality of signals, each spring bar 012 is distributed on branch circuits of different frequency bands of an antenna. For example, as shown in FIG. 3, correspondingly transmitted signals may be a Bluetooth (BT) signal, a Wi-Fi (Wireless-Fidelity) signal, a 4G (the 4th Generation mobile communication technology) signal, a GPS (Global Positioning System) signal, and the like.

However, the watchband 02 in the conventional technology is usually made of metal materials for reasons such as beauty and practicality. After the watchband 02 made of the metal materials is connected to the watch body 01, a circuit of two opposite spring bars 012 is easily conducted. Consequently, an antenna function of the smartwatch is affected, and the antenna performance is significantly reduced.

In some other solutions in the conventional technology, another solution is that a watch housing of a smartwatch uses plastic materials, and a metal antenna pattern may be directly formed on the plastic housing through a laser direct structuring (LDS) technology.

A region between an antenna and a screen and internal metal of the smartwatch is referred to as a clearance region. Generally, good antenna performance requires that the antenna has a clearance region. In the foregoing two solutions, the watch case is used as an antenna. In stacking of the whole machine, the antenna is relatively close to the screen and the internal metal component, and the clearance region is relatively small, thereby limiting the antenna performance.

Refer to FIG. 4. An embodiment of this application provides a wearable device. The wearable device includes a wearable device body 101 and a housing 100 disposed surrounding the wearable device body 101. The housing 100 is made of an insulating material. In an embodiment, a material of the housing 100 may be plastic.

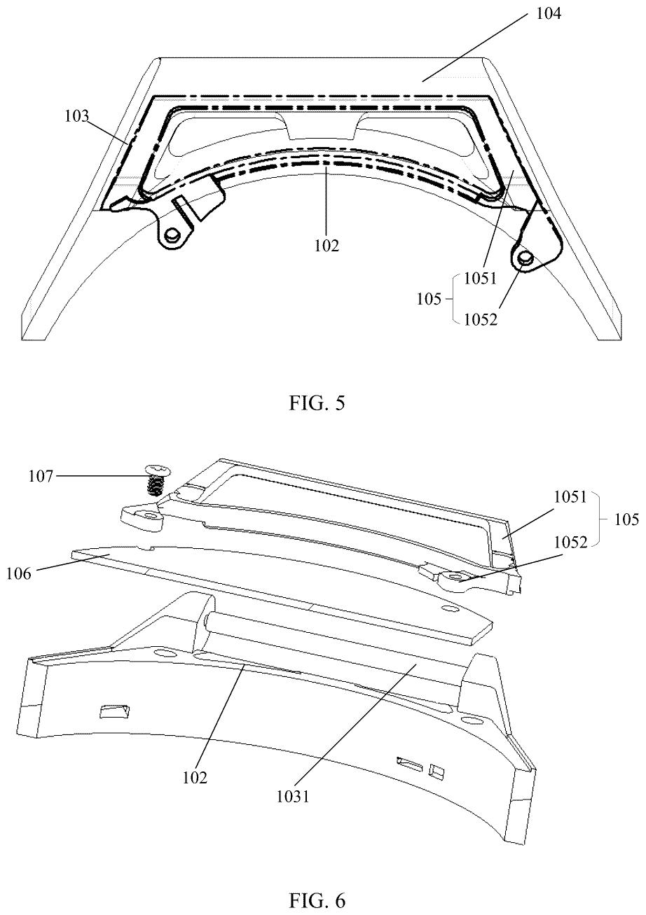

As shown in FIG. 5, a conductive component 105 is embedded in the housing 100.

An assembly manner of the conductive component 105 is not limited in an embodiment of the application. The conductive component 05 may be integrated with the housing 100 through an insert molding manner or another similar molding manner, and is embedded and hidden inside the housing.

In addition, as shown in FIG. 6, the wearable device body 101 includes a mainboard 106. The mainboard 106 is configured to feed power to the conductive component 105, and the conductive component 105 is used as an antenna.

A structure of the conductive component 105 is not limited in an embodiment of the application. In some embodiments, as shown in FIG. 5 and FIG. 6, the conductive component 105 is designed as a U-shaped structure, including an inserting part 1051 embedded in the housing 100 and a connecting part 1052 used to communicatively connect to the mainboard 106. After the inserting part 1051 extends into the housing 100, a metal part of the connecting part 1052 is exposed, and the connecting part 1052 may be directly attached to a part of the mainboard 106 or electrically connected to the mainboard 106 through a metal dome.

As shown in FIG. 4 and FIG. 5, the housing 100 includes spring bars 103.

At least two spring bars 103 are disposed on the wearable device body 101. Two spring bars 103 are arranged in parallel and spaced from each other, and both extend in a same direction. A connection line between ends of the two spring bars 103 is located outside the wearable device body 200. A part of the conductive component 105 is embedded in the spring bars 103.

The watchband 200 of the wearable device correspondingly extends between the two spring bars 103, and the watchband 200 of the wearable device is hinged to the two spring bars 103 of the wearable device body 101 through two spring bar shafts 1031.

It should be noted that, generally, to implement that the watchband 200 of the wearable device may be wound and worn on a corresponding part of a human body (for example, a wrist) after connecting to the wearable device 200, the watchband 200 of the wearable device needs to be connected to the wearable device body 101 at least at two places. That is, at least two groups of spring bars 103 that are in pairs are disposed on the wearable device body 101. In an embodiment, the two groups of spring bars 103 are located on two sides of the wearable device body 101.

As shown in FIG. 6, the wearable device body further includes a spring bar shaft 1031. One spring bar 103 hole is provided on each of the two spring bars 103, the two spring bar 103 holes are coaxially disposed, and two spring bar shafts 1031 extend into the two spring bar 103 holes and are rotatably connected to the spring bar 103 holes.

In addition, as shown in FIG. 8, the conductive component 105 is not in contact with the spring bar shaft 1031 metal, so that the impact of communication connection to the spring bar shaft 1031 on an antenna signal can be avoided.

It should be noted that, to prevent the two opposite spring bars 103 from being electrically connected by the spring bar shaft 1031, an insulation structure may be disposed on the two spring bars 103. For example, in a first possible implementation, a spring bar seat made of an insulating material is embedded in each of the two spring bars 103. The watchband 200 of the wearable device has a first side wall and a second side wall that are opposite to each other. The first side wall is close to one of the two spring bars 103, and the second side wall is close to the other of the two spring bars 103. One of the two spring bar shafts 1031 protrudes from the first side wall, and is connected to a spring bar seat 2011 on the spring bar 103 that is close to the first side wall, and the other of the two spring bar shafts 1031 protrudes from the second side wall, and is connected to a spring bar seat 2011 on the spring bar 103 that is close to the second side wall. The spring bar seat 2011 made of the insulating material may insulate and isolate the spring bar shaft 1031 from the wearable device body 101, further avoiding the impact on the antenna performance of the wearable device.

In a second possible implementation, one spring bar hole is provided on each of the two spring bars 103, two spring bar holes are coaxially disposed, and a surface of an inner wall has an insulation layer. The two spring bar shafts 1031 of the watchband 200 of the wearable device extend into the two spring bar holes. The spring bar shaft 1031 and the spring bar 103 are insulated and isolated through the insulation layer.

The wearable device in this application further includes a band body, and the band body is rotatably connected to the spring bar shaft 1031.

In this way, the conductive component is embedded into the insulating housing through the insert molding manner and is used as the antenna, and the conductive component and a part of the mainboard are designed to be electrically connected, so that the antenna performance of the whole machine is ensured, a seamless design of a whole watch case is also considered, and the surface integrity is implemented.

In addition, the conductive component is disposed at the location of the spring bar. In stacking of the whole machine, the antenna is far away from the screen and the internal metal component, and the clearance region is relatively large. In free space, the antenna performance is improved by at least 3 dB, and the antenna performance is improved. Compared with solutions of the conventional technology, in this solution, the antenna is extended to the housing and has a larger antenna region, and the antenna signal is not interfered by the spring bar shaft, so that the antenna performance of the whole machine is ensured, a seamless design of the whole watch case is also taken into consideration, and the surface integrity is implemented. In addition, open space of the spring bars can be fully used, and is far away from the screen and internal metal stacking, so that a larger clearance region is provided, and the antenna performance is better.

A structure of the housing 100 is not limited in an embodiment of the application. In some embodiments, as shown in FIG. 4 and FIG. 6, the housing 100 includes a circle case 102 disposed surrounding the wearable device body 101, and a part of the conductive component 105 is embedded in the circle case 102.

In this way, the conductive component is extended to the circle case 102, so that the circle case 102 region can be fully used, a size of an antenna radiator is further increased, and the antenna performance is improved.

In some embodiments, as shown in FIG. 4 and FIG. 5, the housing 100 further includes a beam 104. A group of spring bars 103 on a same side are communicatively connected to each other through the beam 104, and a part of the conductive component 105 is embedded in the beam 104.

In this way, the conductive component is extended to the beam, so that the beam region can be fully used, the size of the antenna radiator is further increased, and the antenna performance is improved.

A molding process of the conductive component is not limited in an embodiment of the application. In some embodiments, the conductive component may be formed in the housing 100 through an insert molding manner.

In this way, the conductive component is integrated with a plastic watch case through the insert molding manner or another similar molding manner, and is embedded and hidden inside the plastic watch case, to avoid contact between the antenna and the outside, reduce interference from an external environment to the antenna, and improve performance of the antenna.

In some other embodiments, the conductive component may be formed on a surface of the housing 100 through a laser direct structuring (LDS) process. In the LDS process, a metal antenna pattern may be formed on the formed housing 100 by directly plating on a support through the laser radium technology. In an embodiment, a computer may be used to control motion of a laser based on a track of a conductive pattern, and the laser is projected onto the molded three-dimensional housing 100, so that the circuit pattern is activated within a few seconds.

Therefore, the LDS process is used, so that the operation is simpler, and the production efficiency is improved.

A connection manner of the conductive component 105 and the mainboard 106 is not limited in an embodiment of the application. The mainboard 106 may be conductively connected to the conductive component 105.

In some other embodiments, the mainboard 106 is not directly communicatively connected to the conductive component 105. The mainboard 106 is coupled to the conductive component 105, and the mainboard 106 feeds power to the conductive component 105 in a coupling manner.

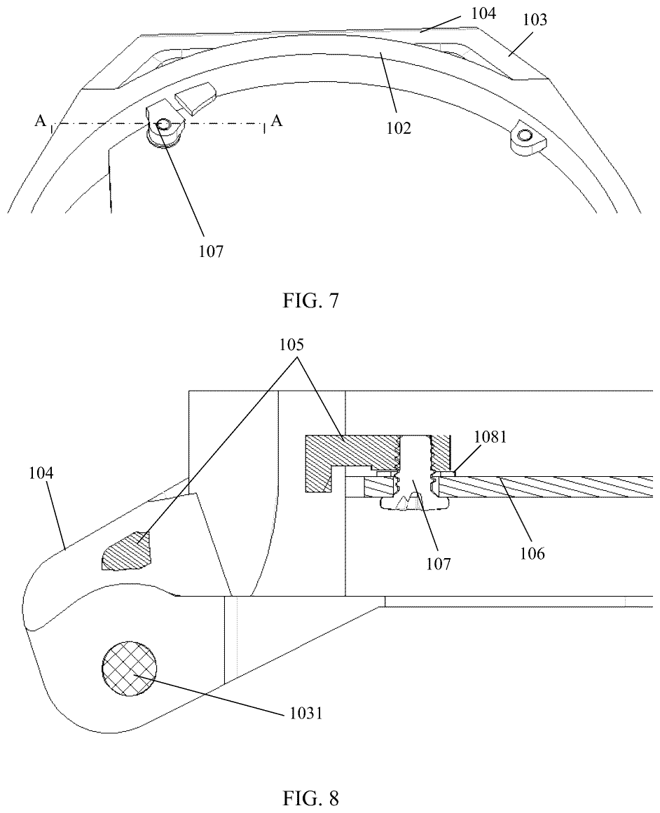

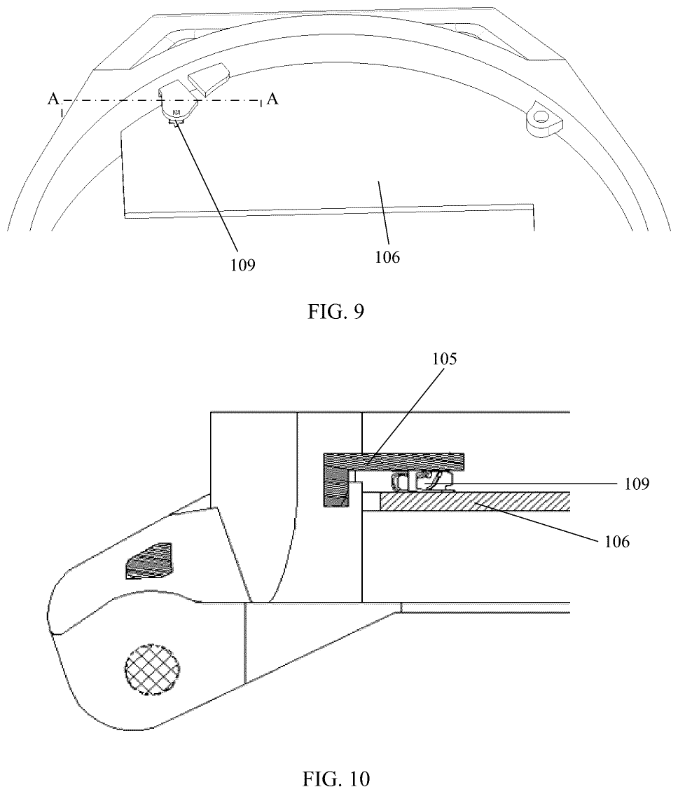

In some other embodiments, as shown in FIG. 7, FIG. 8, FIG. 9, and FIG. 10, the conductive component 105 is electrically connected to the mainboard 106 through an electrical connecting member. A side on which an electromagnetic wave signal is transmitted to the mainboard 106 through an antenna is referred to as an antenna feed point. In an embodiment, a part that is in contact with the mainboard 106 is probed out from an inner side of a plastic watch case (a component and part placement region inside the watch body, which is invisible), and is connected to the mainboard 106 through the electrical connecting member, to implement information exchange between the electromagnetic wave signal and a watch processor. This connection point is also referred to as an antenna feed point.

A structure of the electrical connecting member is not limited in an embodiment of the application. In some embodiments, as shown in FIG. 7 and FIG. 8, the electrical connecting member may be a screw 107. Connecting holes adapted to the screw 107 are provided with both the conductive component 105 and the mainboard 106.

The screw 107 may be connected to a threaded hole on the conductive component 105 and the mainboard 106, and may detachably connected to the threaded hole. When the screw 107 is tightened, the conductive component 105 is conductively connected to the mainboard 106 through the screw 107, and the mainboard 106 may feed power to the conductive component 105 through the screw 107. When the screw 107 is loosened, the conductive component 105 and the mainboard 106 may be disassembled.

In this way, the screw 107 is disposed to facilitate disassembly and installation of the conductive component 105 and the mainboard 106.

In addition, as shown in FIG. 8, to enable an electrical connecting member 107 to be fully contacted with the mainboard 106, a first metal gasket 1081 is disposed between the mainboard 106 and the conductive component 105.

Therefore, the mainboard 106 and the conductive component 105 can be electrically connected without punching a hole on the mainboard 106 and the conductive component 105.

In some other embodiments, the electrical connection may alternatively be a metal dome 109 shown in FIG. 9 and FIG. 10. One end of the metal dome 109 is fastened on the mainboard 106, and the other end presses against a surface of the conductive component 105, so that the mainboard 106 may feed power to the conductive component 105 through the metal dome 109.

In addition, the electrical connection may alternatively be conductive plastic or a flexible printed circuit FPC (not shown in the figure).

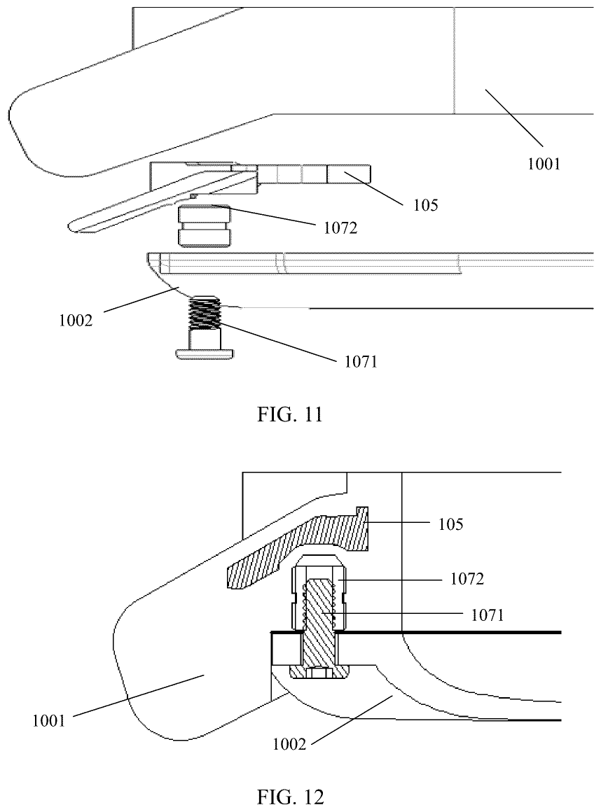

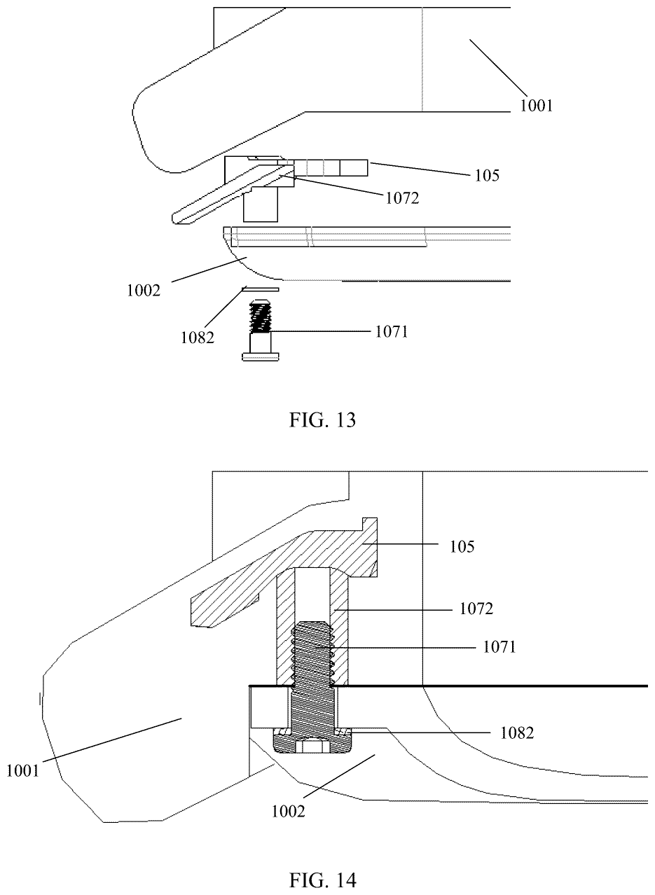

As shown in FIG. 11, FIG. 12, FIG. 13, and FIG. 14, the housing 100 may be divided into a front housing 1001 and a rear housing 1002, and the conductive component 105 is, for example, embedded in the front housing 1001. A second connecting member 1072 may be disposed in the front housing 1001, and the rear housing 1002 and the second connecting member 1072 in the front housing 1001 are detachably connected through the first connecting member 1071.

In some embodiments, as shown in FIG. 11 and FIG. 12, the first connecting member 1071 is a bolt, the second connecting member 1072 is a screw cap, the second connecting member 1072 is embedded in the front housing 1001, and the second connecting member 1072 passes through the rear housing 1002 and is detachably connected to the first connecting member 1071.

In some other embodiments, as shown in FIG. 13 and FIG. 14, the first connecting member 1071 is, for example, a bolt, the second connecting member 1072 is, for example, a screw cap, the second connecting member 1072 and the conductive component 105 are integrally formed, and the first connecting member 1071 passes through the mainboard 106 and is detachably connected to the second connecting member 1072.

Further, as shown in FIG. 13 and FIG. 14, in consideration of an interface waterproof capability of insert molding, a special-shaped sealing ring is designed on a top of a screw hole to ensure a high-level waterproof capability of the whole system, and a second metal gasket 1082 is disposed between the electrical connecting member 107 and the rear housing 1002.

A disposition manner of the conductive component is not limited in an embodiment of the application. In some embodiments, as shown in FIG. 5, the conductive component 105 is of a U-shaped structure, a part of the structure of the conductive component 105 is embedded in the circle case 102, a part is embedded in the spring bar 103, and a remaining part is embedded in the beam 104.

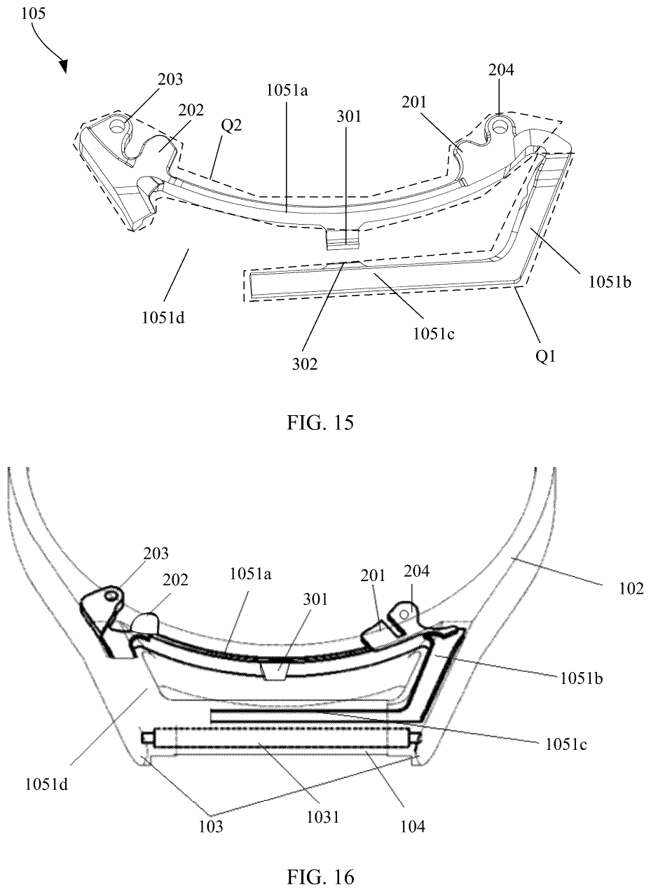

In addition, FIG. 15 is a diagram of a structure of still another conductive component 105, and FIG. 16 further shows a schematic diagram of a structure of disposing the conductive component 105 in FIG. 15 in the housing 100. With reference to FIG. 15 and FIG. 16, because the housing 100 includes the spring bars 103, and the circle case 102 surrounding the wearable device body 101, and further includes the beam 104 connected to a group of spring bars 103 on a same side, an inserting part 1051 of the conductive component 105 may include a first part 1051a embedded in the circle case 102, a second part 1051b embedded in the spring bar 103, and a third part 1051c embedded in the beam 104. A connecting part 1052 is connected to the first part 1051a, and the first part 1051a, the second part 1051b, the third part 1051c, and the connecting part 1052 herein may be integrally formed.

A difference between the conductive component 105 shown in FIG. 15 and the conductive component 105 shown in FIG. 5 lies in that, the third part 1051c embedded in the beam 104 has a slit 1051d. The conductive component 105 of such a structure may implement receiving and sending of signals at an antenna operating frequency around 1.575 GHz (which may be referred to as a GNSS L1 antenna), around 1.176 GHz (which may be referred to as a GNSS L5 antenna), and around 2.4 GHz (which may be referred to as a BT/Wi-Fi antenna). As shown in FIG. 15, it may be schematically considered that a part Q1 in a dashed box can implement signal receiving and sending of the GNSS L1 antenna, and the GNSS L5 antenna and the BT/Wi-Fi antenna share a part Q2 in a dashed box. In other words, the conductive component 105 shown in FIG. 15 and FIG. 16 may implement dual-frequency transmission. In this way, positioning accuracy of the antenna can be significantly improved. For example, precise positioning can still be implemented in a weak-signal region such as a high-rise community or an avenue.

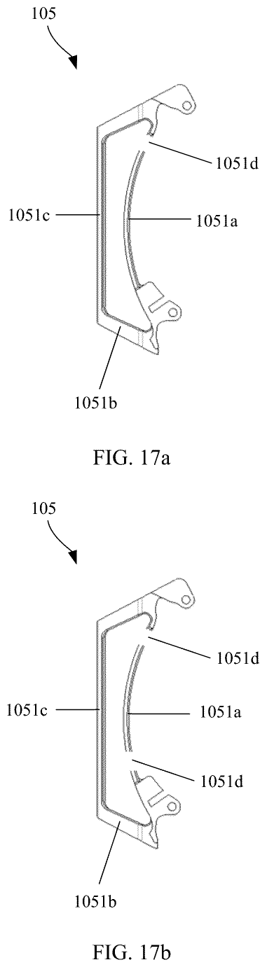

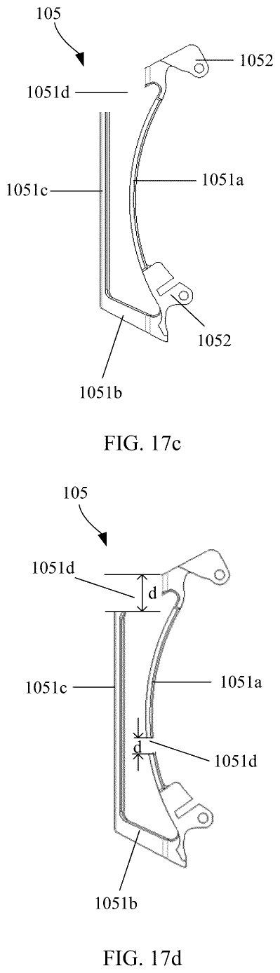

The slit 1051d of the conductive component 105 shown in FIG. 15 and FIG. 16 is disposed on the third part 1051c, and is close to the spring bar 103. In an embodiment, as shown in FIG. 17a and FIG. 17b, the slit 1051d of the conductive component 105 may be disposed on the first part 1051a. Alternatively, as shown in FIG. 17c, the slit 1051d of the conductive component 105 may be disposed on the third part 1051c. Alternatively, as shown in FIG. 17d, both the first part 1051a and the third part 1051c have the slit 1051d.

A quantity of slits 1051d may be one shown in FIG. 15, FIG. 17a, and FIG. 17c, or may be two shown in FIG. 17b and FIG. 17d. In addition, in an embodiment, there may be three or more slits 1051d, or there is no slit 1051d shown in FIG. 5. The location and the quantity of slits 1051d are not limited in this application, and may be determined based on requirements of an antenna operating frequency and bandwidth during implementation. In addition, a width (a size d shown in FIG. 17d) of the slit 1051d is not specially limited. Likewise, a width size may be determined based on requirements of the antenna operating frequency and the bandwidth.

Further, as shown in FIG. 15, in addition to a feed point 204 electrically connected to the mainboard 106, the conductive component 105 provided in this application may further be provided with a grounding point. For example, the conductive component 105 shown in FIG. 15 and FIG. 16 further includes three grounding points: a first grounding point 201, a second grounding point 202, and a third grounding point 203. The first grounding point 201, the second grounding point 202, and the third grounding point 203 are all electrically connected to the mainboard 106. Certainly, only one grounding point, or two grounding points, or more grounding points, or no grounding point may be disposed.

In an embodiments, for example, when a size of the wearable device is limited, a size of the mainboard 106 is relatively small, but a longer earth line is required to improve the antenna performance, a grounding point may be disposed on the conductive component 105 to tune an antenna resonance frequency, thereby improving the antenna performance. It may also be understood as follows: A length of the mainboard 106 may be equivalently extended by disposing a grounding point on the conductive component 105, to improve the antenna performance.

The three grounding points shown in FIG. 15 are all formed on the first part 1051a of the conductive component 105. In an embodiment, the grounding point may be disposed at another location of the conductive component 105, for example, may be disposed on the third part 1051c. In other words, the quantity and the disposed location of grounding points are not limited in this application.

Still as shown in FIG. 15, a first protruding part 301 is formed on a side surface that is of the first part 1051a and that is opposite to the third part 1051c, and a second protruding part 302 is formed on a side surface that is of the third part 1051c and that is opposite to the first part 1051a. During implementation, because a size of the first part 1051a and a size of the third part 1051c are both relatively small, strength of the whole antenna is relatively low, and deformation easily occurs. On the premise of ensuring radio frequency performance of the antenna, the first protruding part 301 and the second protruding part 302 herein may be used as reinforcing ribs to improve strength of the whole antenna.

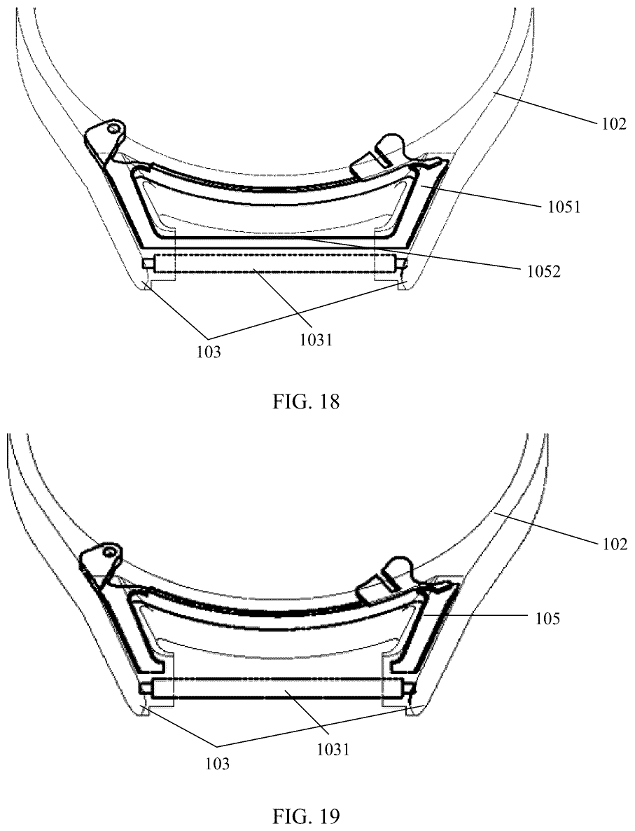

In some other embodiments, as shown in FIG. 18 and FIG. 19, the spring bars 103 at two ends are no longer in the state shown in FIG. 5 in which the spring bars 103 are connected to each other through the beam 104, and the metal antenna module has different forms. The spring bars 103 on one side may be exposed and connected to each other, or may not be connected to each other.

As shown in FIG. 18, an insert of the conductive component 105 is only molded into a bezel part of the watch case, a part of a structure of the conductive component 105 is hidden in the bezel part of the watch case, and a remaining part is exposed.

Refer to FIG. 18. A part of the structure of the conductive component 105 is embedded in a circle case 102, another part is embedded in spring bars 103, and a remaining part is located between two spring bars 103 on one side, and is exposed from a housing. Therefore, a part of the conductive component 105 is exposed from the watch case, so that space of the spring bars can be fully used to improve the antenna performance.

In some other embodiments, as shown in FIG. 19, an insert of the conductive component 105 is only molded into a bezel part of the watch case.

Refer to FIG. 19. A part of a structure of the conductive component 105 is embedded in a circle case 102, and the other part is embedded in spring bars 103. The conductive component 105 is disconnected between two spring bars 103 on one side, and the conductive component 105 is completely hidden in the bezel of the watch case, so as to have a more integrated and complete appearance.

It should be noted that, a part in which the spring bar 103 connected to the spring bar shaft 1031 is kept insulated, to prevent the spring bar shaft 1031 from being communicatively connected to the conductive component 105, so that the antenna performance is improved.

In the wearable device, because two groups of spring bars 103 are included, and two spring bars 103 of each group of spring bars 103 are disposed on a same side, in an embodiment, a conductive component 105 may be disposed at a location of each group of the two groups of spring bars 103, or a conductive component 105 may be disposed at a location of only one group of spring bars 103, and no conductive component may be disposed at the other group of spring bars 103. The following provides a plurality of conductive components 105 of different shapes. For detailed descriptions, refer to the following.

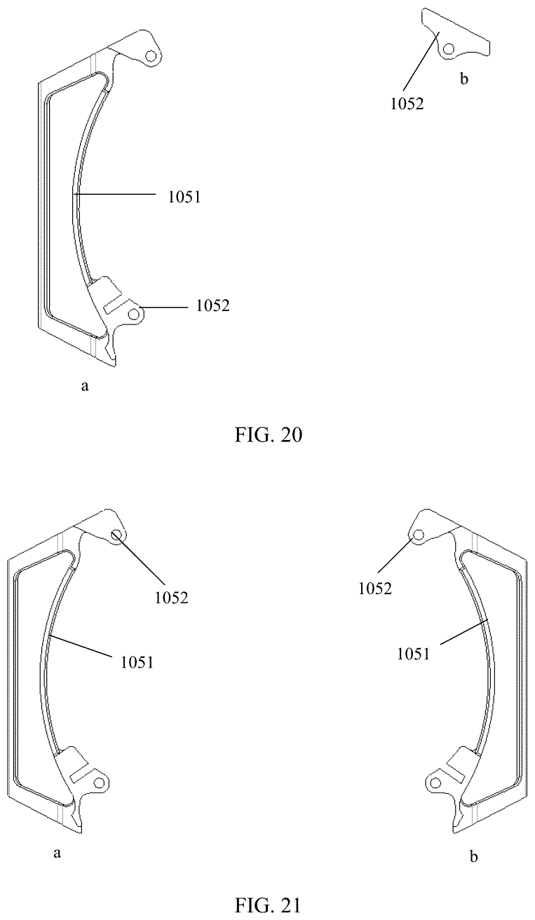

A shape of the conductive component 105 is not limited in an embodiment of the application. In some embodiments, the conductive component may use a structure shown in a module a in FIG. 20. The module a uses a U-shaped structure, and includes an inserting part 1051 embedded in the housing and a connecting part 1052 used to connect to the mainboard.

In some other embodiments, the conductive component 105 may alternatively use a structure shown in a module b in FIG. 20, and include only a connecting part 1052 used to connect to the mainboard.

In other embodiments, the conductive component may be divided into a plurality of modules, and the conductive component may also use a structure shown in a module a and a module b in FIG. 21. The module a and the module b may be a complete conductive component formed by disconnecting at a middle position. The module a and the module b may be used as different antenna modules, and may work on different frequency bands. The plurality of modules corresponds to a GPS antenna, a Bluetooth antenna, and a Wi-Fi antenna.

It should be noted that a complete antenna module includes at least one connecting part 1052, or has at least one feed point. One of ordinary skilled in the art may flexibly select a shape of each conductive component as required. The conductive component may be an entirety, or may include only the connecting part 1052, or may be divided into a plurality of modules. All these fall within the protection scope of this application.

In an embodiment, as shown in FIG. 20, a smartwatch includes two metal modules. One metal module a uses a complete U-shaped structure, and includes an inserting part 1051 embedded in a housing and a connecting part 1052 used to connect to the mainboard. The other metal module b includes only a connecting part 1052 used to connect to the mainboard. The module a and the module b may be used as different antenna modules, and may work on different frequency bands.

As shown in FIG. 21, a smartwatch includes two metal modules. Both a module a and a module b use a complete U-shaped structure, and both the module a and the module b include an inserting part embedded in a housing and a connecting part used to connect to a mainboard. The module a and the module b may be used as different antenna modules, and may work on different frequency bands.

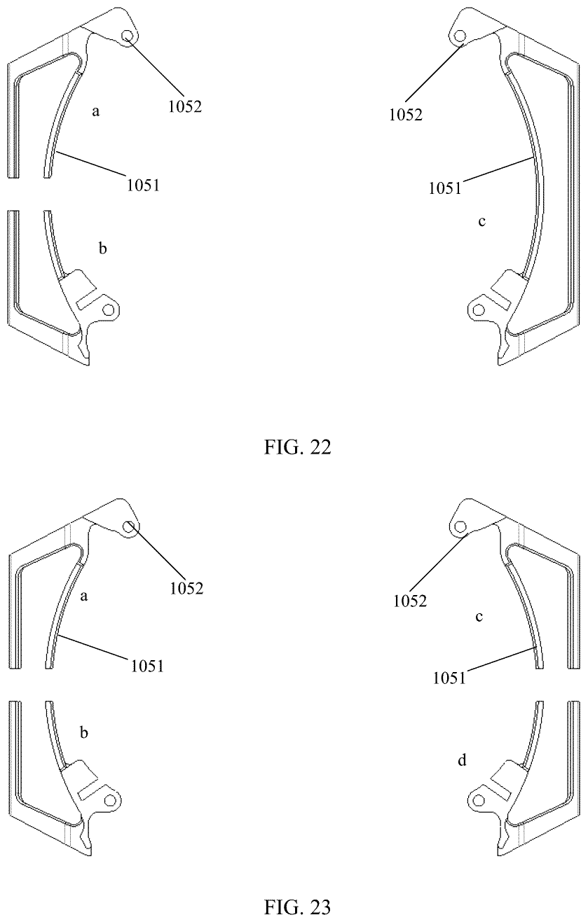

As shown in FIG. 22, a smartwatch includes three metal modules. A module a and a module b are formed by disconnecting a conductive component. A module c uses a complete U-shaped structure, and includes an inserting part 1051 embedded in a housing and a connecting part 1052 used to connect to a mainboard. The module a, the module b, and the module c may be used as different antenna modules, and may work on different frequency bands.

As shown in FIG. 23, a smartwatch includes four metal modules. A module a and a module b are formed by disconnecting a conductive component in a middle position, and a module c and a module d are formed due to a breakpoint in a middle position of another conductive component. The module a, the module b, the module c, and the module d may be used as different antenna modules, and may work on different frequency bands.

For example, the module a, the module b, the module c, and the module d may be respectively used as a GPS antenna, a Bluetooth antenna, a Wi-Fi antenna, and a communication antenna. A correspondence between each module and an antenna module is not limited in an embodiment of the application, and one of ordinary skilled in the art may set a correspondence as required. All these fall within the protection scope of this application.

Therefore, the conductive component 105 has one or more breakpoints, so that the conductive component 105 is divided into a plurality of modules, and each module may independently be used as an antenna of a signal frequency band, thereby bringing better antenna performance to the watch compared with a conventional antenna structure.

In addition, embodiments of this application further provides the following several implementations, which are as follows:

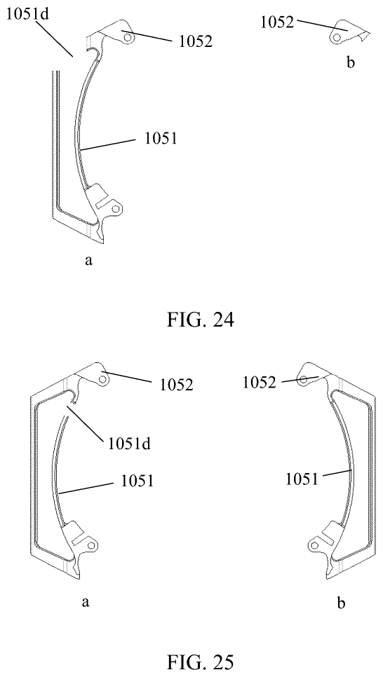

In some embodiments, as shown in FIG. 24, a module a disposed at a group of spring bars 103 may form a slit 1051d on an inserting part 1051, and a module b is the same as the module b in FIG. 20, and includes only a connecting part 1052 connected to the mainboard. In still other embodiments, as shown in FIG. 25, a module a disposed at a pair of spring bars 103 may form a slit 1051d on an inserting part 1051. A location of the slit 1051d in this embodiment is different from a location of the slit 1051d in the module a in FIG. 24, and a structure of a module b is the same as that of the module b in FIG. 21.

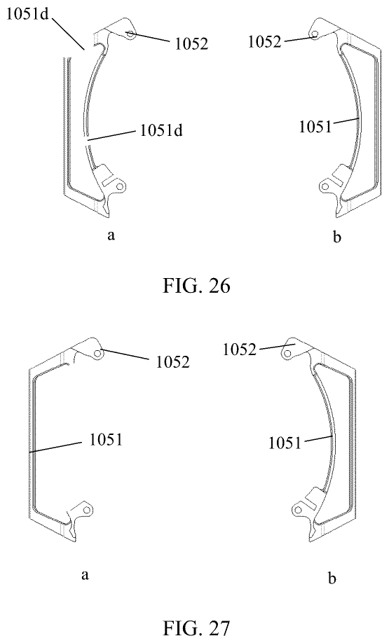

In yet other embodiments, as shown in FIG. 26, a module a disposed at a group of spring bars 103 may form a slit 1051d on an inserting part 1051, and there are at least two slits 1051d, and a module b has a same structure as the module a in FIG. 25.

In yet other embodiments, an inserting part 1051 of a module a disposed at a group of spring bars 103 in FIG. 27 does not include a part disposed on the circle case 102, and a module b has a same structure as the module b in FIG. 26.

It should be noted that the foregoing provides only shapes of partial conductive components 105 provided in this application, and another shape also falls within the protection scope of this application, and are not exhaustive herein.

For the conductive component 105 shown in FIG. 20 and FIG. 24, the module a may be used as a GNSS L1 antenna, a GNSS L5 antenna, and a BT/Wi-Fi antenna, and the module b may be used as a connecting member for connecting the antenna and the mainboard.

In addition, for the conductive components shown in FIG. 21, FIG. 22, FIG. 23, FIG. 25, FIG. 26, and FIG. 27, a conductive component located on a left side is used as an antenna, and a conductive component located on a right side may be designed as extension ground of a mainboard. In this way, performance of the antenna located on the left side may be further improved. In an embodiment, the conductive component located on the right side may be electrically connected to the mainboard directly, or may be electrically connected to the mainboard by using an inductor and/or a capacitor. For the conductive component on the right side, a location and a width of a slit may be adjusted based on an antenna requirement.

Further, in an embodiment, for the conductive components shown in FIG. 21, FIG. 22, FIG. 23, FIG. 25, FIG. 26, and FIG. 27, both a conductive component located on a left side and a conductive component located on a right side may be designed as antennas, and may be designed as antenna combinations of different frequency bands. For example, the conductive component on the left side may be designed as a GNSS L1 antenna, a GNSS L5 antenna, and a BT/Wi-Fi antenna, and the conductive component on the right side may be designed as a cellular antenna or an antenna of another frequency band.

The foregoing descriptions are merely embodiments of this application, but are not intended to limit the protection scope of this application. Any variation or replacement within the technical scope disclosed in this application shall fall within the protection scope of this application. Therefore, the protection scope of this application shall be subject to the protection scope of the claims.

1. A wearable device, comprising:
a wearable device body comprising a mainboard configured to feed power to a conductive component used as an antenna, and
a housing that covers the wearable device body, wherein the housing is made of an insulating material, the housing comprising:
at least two spring bars arranged in parallel and spaced from each other and both extend in a same direction,
a connection line between ends of the two spring bars is located outside the wearable device body, and
the conductive component disposed on the spring bar.

2. The wearable device according to claim 1, wherein a circle case is disposed surrounding the wearable device body, the spring bar is disposed on the circle case, and a part of the conductive component is disposed in the circle case.

3. The wearable device according to claim 1, wherein two spring bars on a same side of the wearable device body are communicatively connected to each other through a beam, and a part of the conductive component is disposed in the beam.

4. The wearable device according to claim 3, wherein the conductive component comprises:
a first part disposed on the circle case,
a second part disposed on the spring bar, and
a third part disposed on the beam, wherein the first part, the second part, and the third part are connected, and there is a slit on the third part.

5. The wearable device according to claim 4, wherein a location of the slit is close to the spring bar.

6. The wearable device according to claim 4, wherein the first part has a grounding point electrically connected to the mainboard.

7. The wearable device according to claim 4, wherein a first protruding part is formed on a side surface of the first part and opposite to the third part, a second protruding part is formed on a side surface of the third part and opposite to the first part, and the first protruding part is electrically isolated from the second protruding part.

8. The wearable device according to claim 1, wherein the conductive component is embedded in the spring bar.

9. The wearable device according to claim 1, wherein the conductive component is formed on a surface of the spring bar.

10. The wearable device according to claim 1, wherein the mainboard is coupled to the conductive component.

11. The wearable device according to claim 1, wherein the conductive component is electrically connected to the mainboard through an electrical connecting member.

12. The wearable device according to claim 11, wherein the electrical connecting member is one of a screw, a metal dome, conductive plastic, or a flexible printed circuit FPC.

13. The wearable device according to claim 1, wherein the housing comprises:
a front housing, and
a rear housing, wherein the conductive component is located in the front housing.

14. The wearable device according to claim 13, wherein a first connecting member is further disposed in the front housing, a second connecting member is disposed in the rear housing, and the first connecting member is detachably connected to the second connecting member.

15. The wearable device according to claim 14, wherein the first connecting member is embedded in the front housing.

16. The wearable device according to claim 14, wherein the first connecting member and the conductive component are integrally formed.

17. The wearable device according to claim 13, wherein a sealing gasket is disposed between the rear housing and the second connecting member.

18. The wearable device according to claim 13, wherein
the first connecting member is a screw, and the second connecting member is a nut, or
the first connecting member is a nut, and the second connecting member is a screw.

19. The wearable device according to claim 1, wherein the conductive component comprises:
a plurality of modules, wherein different modules correspond to different operating frequency bands.

20. The wearable device according to claim 1, further comprising:
a spring bar shaft, wherein one spring bar hole is provided on each of the two spring bars, two spring bar holes are coaxially disposed, two spring bar shafts extend into the two spring bar holes and are rotatably connected to the spring bar holes, and the spring bar shaft and the conductive component are spaced from each other.

21. (canceled)
